(19) United States
(12) Patent Application Publication
(10) Pub. No.: US 2008/0192378 A1
(43) Pub. Date: Aug. 14, 2008

(54) ADAPTIVE DATA-DEPENDENT NOISE PREDICTION (DDNP)

(75) Inventors: William Gene Bliss, Thornton, CO (US); Xiaotong Lin, San Jose, CA (US)

Correspondence Address: GARLICK HARRISON & MARKISON, P.O. BOX 160727, AUSTIN, TX, 78716-0727, US

(73) Assignee: BROADCOM CORPORATION, Irvine, CA (US)

(21) Appl. No.: 12/023,300

(22) Filed: Jan. 31, 2008

Related U.S. Application Data
(60) Provisional application No. 60/889,799, filed on Feb. 14, 2007.

(51) Int. Cl. G11B 15/18

(52) U.S. Cl. 360/69

(57) ABSTRACT

A data-dependent noise predictive (DDNP) adaptation module operable to support Viterbi branch metric calculations within a hard disk drive (HDD) controller is provided. This DDNP adaptation module includes a DDNP filter tap coefficient adaptation module, a DDNP filter gain scaling module, and a DDNP bias compensation module. The combination of the DDNP filter tap coefficient adaptation module, the DDNP filter gain scaling module, and the DDNP bias compensation module is operable to receive an error signal and a NRZ pattern and produce tap coefficients. A whitened error signal calculation module coupled to the DDNP filter tap coefficient adaptation module, the DDNP filter gain scaling module, and the DDNP bias compensation module, the whitened error signal calculation module operable to calculate a whitened error signal based on the error signal, NRZ pattern, and tap coefficients. This whitened error signal is used to support the Viterbi branch metric calculations.

### CROSS REFERENCE TO RELATED APPLICATIONS

The present U.S. Utility patent application claims priority pursuant to 35 U.S.C. § 119(e) to the following U.S. Provisional Patent Application which is hereby incorporated herein by reference in its entirety and made part of the present U.S. Utility patent application for all purposes:

1. U.S. Provisional Application Ser. No. 60/889,799, entitled “ADAPTIVE DATA-DEPENDENT NOISE PREDICTION,” (Attorney Docket No. BP5832), filed Feb. 17, 2007, pending.

### TECHNICAL FIELD OF THE INVENTION

Embodiments of the present invention relate generally to memory storage devices; and, more particularly, embodiments of the present invention relate to noise components within a magnetic recording channel.

### BACKGROUND OF THE INVENTION

As is known, many varieties of memory storage devices (e.g. disk drives), such as magnetic disk drives are used to provide data storage for a host device, either directly, or through a network such as a storage area network (SAN) or network attached storage (NAS). Typical host devices include stand alone computer systems such as a desktop or laptop computer, enterprise storage devices such as servers, storage arrays such as a redundant array of independent disks (RAID) arrays, storage routers, storage switches and storage directors, and other consumer devices such as video game systems and digital video recorders. These devices provide high storage capacity in a cost effective manner.

The structure and operation of hard disk drives is generally known. Hard disk drives include, generally, a case, a hard disk having magnetically alterable properties, and a read/write mechanism including Read/Write (RW) heads operable to write data to the hard disk by locally alerting the magnetic properties of the hard disk and to read data from the hard disk by reading local magnetic properties of the hard disk. The hard disk may include multiple platters, each platter being a planar disk.

All information stored on the hard disk is recorded in tracks, which are concentric circles organized on the surface of the platters. Data stored on the disks may be accessed by moving RW heads radially as driven by a head actuator to the radial location of the track containing the data. To efficiently and quickly access this data, fine control of RW hard positioning is required. The track-based organization of data on the hard disk(s) allows for easy access to any part of the disk, which is why hard disk drives are called “random access” storage devices.

Since each track typically holds many thousands of bytes of data, the tracks are further divided into smaller units called sectors. This reduces the amount of space wasted by small files. Each sector holds 512 bytes of user data, plus as many as a few dozen additional bytes used for internal drive control and for error detection and correction.

With increases in data density stored to the hard disk, the effects of noise components within the channel are increased.

### SUMMARY OF THE INVENTION

Embodiments of the present invention are directed to systems and methods that are further described in the following description and claims. Advantages and features of embodiments of the present invention may become apparent from the description, accompanying drawings and claims.

### BRIEF DESCRIPTION OF THE DRAWINGS

For a more complete understanding of the present invention and the advantages thereof, reference is now made to the following description taken in conjunction with the accompanying drawings in which like reference numerals indicate like features and wherein:

FIG. 1 depicts an embodiment of a disk drive unit in accordance with an embodiment of the present invention;

FIG. 2 illustrates an embodiment of a disk controller in accordance with an embodiment of the present invention;

FIGS. 3A through 3E depicts embodiments of various devoices that employ disk drive units in accordance with an embodiment of the present invention;

FIG. 4 is a block diagram of a read digital datapath having DDNP adaptation module in accordance with embodiments of the present invention;

FIG. 5 is a block diagram of DDNP adaptation block of FIG. 4 in further detail in accordance with embodiments of the present invention;

FIG. 6 is a representation of one embodiment of a reconstructed filter module in accordance with embodiments of the present invention;

FIG. 7 is a representation of one embodiment of a reconstructed filter module used for recalculation of Viterbi Ideal Branch Metrics in accordance with embodiments of the present invention;

FIG. 8 is a representation of a DDNP Whitener Coefficient Adaptation block in accordance with embodiments of the present invention; and

FIG. 9 provides a logic flow diagram for performing DDNP in accordance with the embodiments of the present invention.

### DETAILED DESCRIPTION OF THE INVENTION

Embodiments of the present invention are illustrated in the FIGS., like numerals being used to refer to like and corresponding parts of the various drawings.

Embodiments of the present invention provide a system and method to support Viterbi branch metric calculations that support magnetic read channel operations. In magnetic recording channel, noise components in readback signals are correlated and user pattern dependent due to media noise, front-end equalizer and nonlinearity factors. In order to optimize the performance of sequence detector, data-dependent noise predictive (DDNP) filters (or called whiteners) and data-dependent bias compensation terms are used in Viterbi branch metric calculation. DDNP settings (including whiteners and biases) are obtained using on-the-fly DDNP adaptation. On-the-fly adaptation provides a ‘self-contained’ feature that allows one to ‘automatically’ acquire DDNP settings through internal channel circuits.

On-the-fly DDNP adaptation will be supported in three scenarios: self-scan mode during manufacturing, pre-read mode when a drive is seeking for particular sector to read and normal read mode. In self-scan mode during manufacturing, DDNP will be calibrated for every zone and the calibrated settings will be stored in zone tables, and later loaded to channel registers so that in read mode users can start with very good initial settings. Known NRZ data pattern, such as a pseudo-random sequence generated by a linear feedback shift register (LFSR), will be used in self-scan calibration. It is desired to do a speedy zone calibration, say on the order of one revolution. For 1″ drives, there are around 50˜100 4 k-byte sectors from ID to OD on a track.

DDNP adaptation is also desired to continuously track any environment changes when HDDs are shipped out of factories, such as in pre-read mode and normal read mode. Since in read mode, NRZ estimates rather than known data patterns will be applied in adaptation, slow loop would work better by dialing in small loop updating gain.

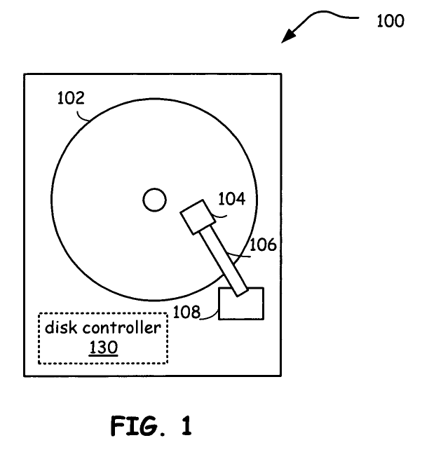

FIG. 1 illustrates an embodiment of a disk drive unit 100. In particular, disk drive unit 100 includes a disk 102 that is rotated by a servo motor (not specifically shown) at a velocity such as 3600 revolutions per minute (RPM), 4200 RPM, 4800 RPM, 5,400 RPM, 7,200 RPM, 10,000 RPM, 15,000 RPM, however, other velocities including greater or lesser velocities may likewise be used, depending on the particular application and implementation in a host device. In one possible embodiment, disk 102 can be a magnetic disk that stores information as magnetic field changes on some type of magnetic medium. The medium can be a rigid or non-rigid, removable or non-removable, that consists of or is coated with magnetic material.

Disk drive unit 100 further includes one or more read/write (RW) heads 104 that are coupled to arm 106 that is moved by actuator 108 over the surface of the disk 102 either by translation, rotation or both. The head assembly may also be referred to as a head gimbal assembly (HGA) that positions a RW head, which in some embodiments may be a thin-film magnetic head, to record and read magnetic information into and from a recording surface of a hard disk or recording medium rotating at high speed. Pre-amplifier (within the RW head or located between the RW head and the disk controller) may be used to condition the signals to and from the RW head. Disk controller 130 is included for controlling the read and write operations to and from the drive, for controlling the speed of the servo motor and the motion of actuator 108, and for providing an interface to and from the host device.

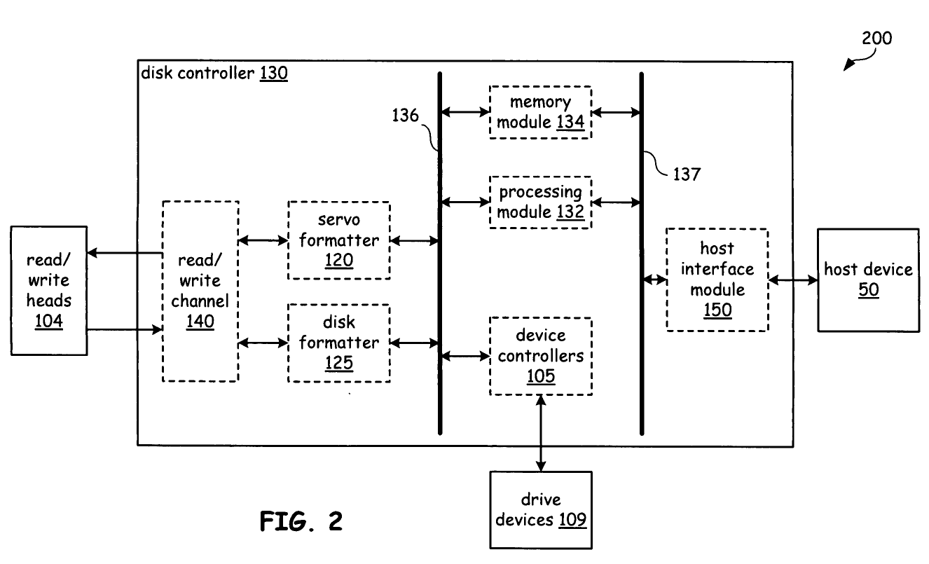

FIG. 2 illustrates an embodiment of an apparatus 200 that includes a disk controller 130. In particular, disk controller 130 includes a read/write channel 140 for reading and writing data to and from disk 102 through read/write heads 104. Disk formatter 125 is included for controlling the formatting of data and provides clock signals and other timing signals that control the flow of the data written to, and data read from disk 102. Servo formatter 120 provides clock signals and other timing signals based on servo control data read from disk 102. Device controllers 105 control the operation of drive devices 109 such as actuator 108 and the servo motor, etc. Host interface 150 receives read and write commands from host device 50 and transmits data read from disk 102 along with other control information in accordance with a host interface protocol. In one embodiment, the host interface protocol can include, SCSI, SATA, enhanced integrated drive electronics (EIDE), or any number of other host interface protocols, either open or proprietary that can be used for this purpose.

Disk controller 130 further includes a processing module 132 and memory module 134. Processing module 132 can be implemented using one or more microprocessors, micro-controllers, digital signal processors, microcomputers, central processing units, field programmable gate arrays, programmable logic devices, state machines, logic circuits, analog circuits, digital circuits, and/or any devices that manipulates signal (analog and/or digital) based on operational instructions that are stored in memory module 134. When processing module 132 is implemented with two or more devices, each device can perform the same steps, processes or functions in order to provide fault tolerance or redundancy. Alternatively, the function, steps and processes performed by processing module 132 can be split between different devices to provide greater computational speed and/or efficiency.

Memory module 134 may be a single memory device or a plurality of memory devices. Such a memory device may be a read-only memory, random access memory, volatile memory, non-volatile memory, static random access memory (SRAM), dynamic random access memory (DRAM), flash memory, cache memory, and/or any device that stores digital information. Note that when the processing module 132 implements one or more of its functions via a state machine, analog circuitry, digital circuitry, and/or logic circuitry, the memory module 134 storing the corresponding operational instructions may be embedded within, or external to, the circuitry comprising the state machine, analog circuitry, digital circuitry, and/or logic circuitry. Further note that, the memory module 134 stores, and the processing module 132 executes, operational instructions that can correspond to one or more of the steps or a process, method and/or function illustrated herein.

Disk controller 130 includes a plurality of modules, in particular, device controllers 105, processing module 132, memory module 134, read/write channel 140, disk formatter 125, and servo formatter 120 that are interconnected via bus 136 and bus 137. The host interface 150 can be connected to only the bus 137 and communicates with the host device 50. Each of these modules can be implemented in hardware, firmware, software or a combination thereof, in accordance with the broad scope of the present invention. While a particular bus architecture is shown in FIG. 2 with buses 136 and 137, alternative bus architectures that include either a single bus configuration or additional data buses, further connectivity, such as direct connectivity between the various modules, are likewise possible to implement the features and functions included in various embodiments.

In one possible embodiment, one or more modules of disk controller 130 are implemented as part of a system on a chip (SoC) integrated circuit. In an embodiment, this SoC integrated circuit includes a digital portion that can include additional modules such as protocol converters, linear block code encoding and decoding modules, etc., and an analog portion that includes device controllers 105 and optionally additional modules, such as a power supply, etc. In a further embodiment, the various functions and features of disk controller 130 are implemented in a plurality of integrated circuit devices that communicate and combine to perform the functionality of disk controller 130.

When the drive unit 100 is manufactured, disk formatter 125 writes a plurality of servo wedges along with a corresponding plurality of servo address marks at equal radial distance along the disk 102. The servo address marks are used by the timing generator for triggering the “start time” for various events employed when accessing the media of the disk 102 through read/write heads 104.

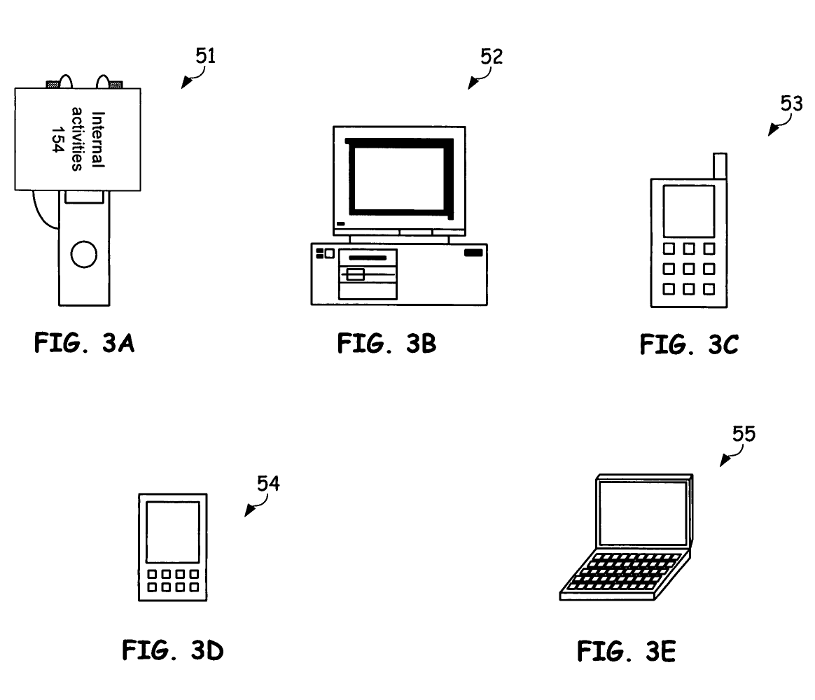

FIG. 3A illustrates an embodiment of a handheld audio unit 51. In particular, disk drive unit 100 can be implemented in the handheld audio unit 51. In one possible embodiment, the disk drive unit 100 can include a small form factor magnetic hard disk whose disk 102 has a diameter 1.8″ or smaller that is incorporated into or otherwise used by handheld audio unit 51 to provide general storage or storage of audio content such as motion picture expert group (MPEG) audio layer 3 (MP3) files or Windows Media Architecture (WMA) files, video content such as MPEG4 files for playback to a user, and/or any other type of information that may be stored in a digital format.

FIG. 3B illustrates an embodiment of a computer 52. In particular, disk drive unit 100 can be implemented in the computer 52. In one possible embodiment, disk drive unit 100 can include a small form factor magnetic hard disk whose disk 102 has a diameter 1.8″ or smaller, a 2.5″ or 3.5″ drive or larger drive for applications such as enterprise storage applications. Disk drive 100 is incorporated into or otherwise used by computer 52 to provide general purpose storage for any type of information in digital format. Computer 52 can be a desktop computer, or an enterprise storage devices such a server, of a host computer that is attached to a storage array such as a redundant array of independent disks (RAID) array, storage router, edge router, storage switch and/or storage director.

FIG. 3C illustrates an embodiment of a wireless communication device 53. In particular, disk drive unit 100 can be implemented in the wireless communication device 53. In one possible embodiment, disk drive unit 100 can include a small form factor magnetic hard disk whose disk 102 has a diameter 1.8″ or smaller that is incorporated into or otherwise used by wireless communication device 53 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats that may be captured by an integrated camera or downloaded to the wireless communication device 53, emails, webpage information and other information downloaded from the Internet, address book information, and/or any other type of information that may be stored in a digital format.

In a possible embodiment, wireless communication device 53 is capable of communicating via a wireless telephone network such as a cellular, personal communications service (PCS), general packet radio service (GPRS), global system for mobile communications (GSM), and integrated digital enhanced network (iDEN) or other wireless communications network capable of sending and receiving telephone calls. Further, wireless communication device 53 is capable of communicating via the Internet to access email, download content, access websites, and provide steaming audio and/or video programming. In this fashion, wireless communication device 53 can place and receive telephone calls, text messages such as emails, short message service (SMS) messages, pages and other data messages that can include attachments such as documents, audio files, video files, images and other graphics.

FIG. 3D illustrates an embodiment of a personal digital assistant (PDA) 54. In particular, disk drive unit 100 can be implemented in the personal digital assistant (PDA) 54. In one possible embodiment, disk drive unit 100 can include a small form factor magnetic hard disk whose disk 102 has a diameter 1.8″ or smaller that is incorporated into or otherwise used by personal digital assistant 54 to provide general storage or storage of audio content such as motion picture expert group (MPEG) audio layer 3 (MP3) files or Windows Media Architecture (WMA) files, video content such as MPEG4 files, JPEG (joint photographic expert group) files, bitmap files and files stored in other graphics formats, emails, webpage information and other information downloaded from the Internet, address book information, and/or any other type of information that may be stored in a digital format.

FIG. 3E illustrates an embodiment of a laptop computer 55. In particular, disk drive unit 100 can be implemented in the laptop computer 55. In one possible embodiment, disk drive unit 100 can include a small form factor magnetic hard disk whose disk 102 has a diameter 1.8″ or smaller, or a 2.5″ drive. Disk drive 100 is incorporated into or otherwise used by laptop computer 52 to provide general purpose storage for any type of information in digital format.

Data recorded on magnetic disk platters in a drive follow a complex analog path from being initially “read” to final digitization in a read-channel. The feature-rich analog front end (AFE) of a read channel integrates multiple technologies in a single design used for horizontal (also known as longitudinal) recording techniques and higher capacity perpendicular recording. However, perpendicular recording may exhibit increased asymmetry when compare to horizontal recording which is symmetric with even symmetry. This may increase the processing demands placed on the AFE.

In the magnetic recording channel of a hard disk drive (HDD) or like media storage, noise components in the readback signals are correlated and user pattern dependent due to media noise, front-end equalizer and nonlinearity factors. In order to optimize the performance of sequence detector, data-dependent noise predictive (DDNP) filters (often referred to as whiteners) and data-dependent bias compensation terms are used in Viterbi branch metric calculation. There are generally two approaches to obtain DDNP settings (including whiteners and biases): (1) offline calibration; (2) and on-the-fly (OTF) DDNP adaptation. In offline calibration approach, noise statistics are collected in channel and passed to an offline processor, where the Yule-Walker sole solution or other may be applied involving matrix inversion operations to calculate DDNP filter coefficients. The DDNP-Viterbi ideal branch values are then calculated based on DDNP filters and biases. While the offline calibration approach involves inconvenient interactions between channel and offline processor, the OTF adaptation is a more ‘self-contained’ feature that users can turn on to ‘automatically’ acquire DDNP settings through internal channel circuits. This feature may be utilized in at least the following three scenarios: (1) self-scan mode during manufacturing; (2) pre-read mode when a drive is seeking for particular sector to read; and (3) normal read mode. In self-scan mode during manufacturing, DDNP may be calibrated for every zone and the calibrated settings may be stored in zone tables, and later loaded to channel registers so that in read mode users can start with good initial settings. Known NRZ data pattern, such as a pseudo-random sequence generated by a linear feedback shift register (LFSR), may be used in self-scan calibration.

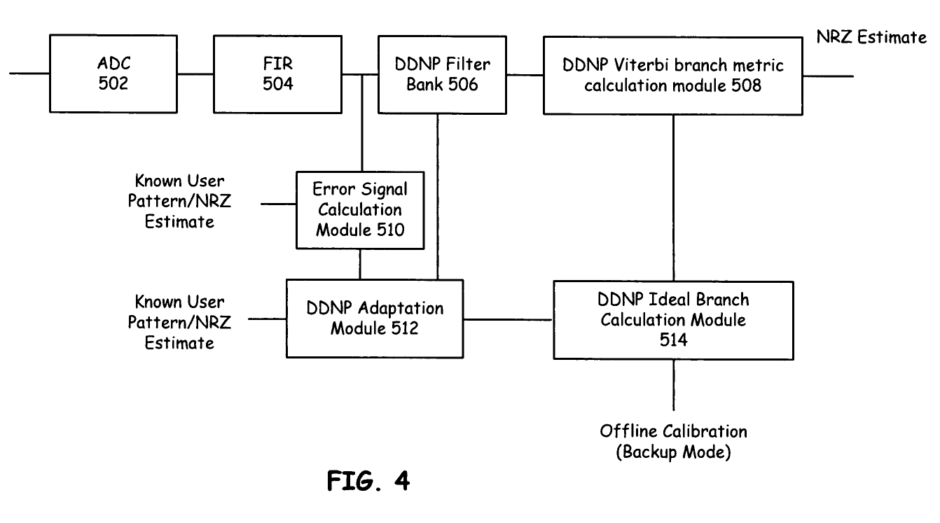

FIG. 4 is a block diagram of a read digital data path having DDNP adaptation. Read Digital Path 500 includes ADC 502, FIR 504, DDNP filter bank 506, DDNP Viterbi branch metric calculation module 508, error signal calculation module 510, DDNP OTF adaptation module 512 and DDNP ideal branch calculation module 514. As shown in FIG. 4, DDNP adaptation block 512 provides information to DDNP filter bank 506 and DDNP ideal branch metrics 514 for Viterbi branch metric calculation. The input signals to drive DDNP adaptation block are error signals produced based on FIR module 504 output and NRZ pattern. (known data pattern in self-scan mode and NRZ estimate from Viterbi detector in read mode).

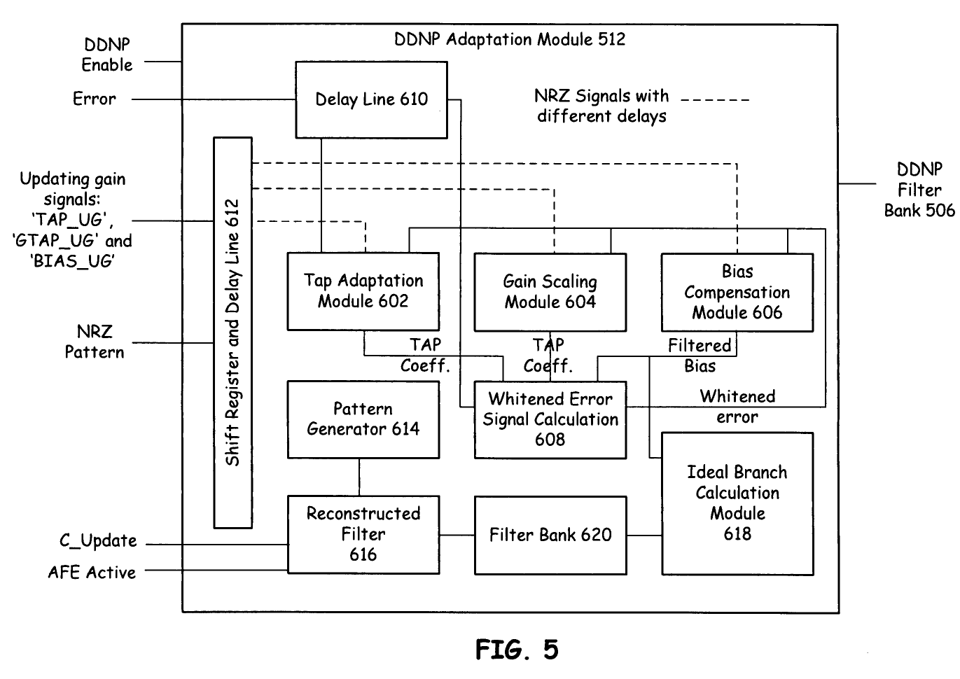

FIG. 5 is a block diagram of DDNP adaptation block of FIG. 4 in further detail in accordance with embodiments of the present invention. As shown in FIG. 5, the DDNP adaptation block 512 includes 3 adaptation sub-blocks: DDNP filter tap coefficients adaptation 602; DDNP filter gain scaling 604; and DDNP bias compensation 606; a whitened error signal calculation block 608; shift register and delay line 610; delay line 612; pattern generator 614; filter bank 620; ideal branch metric calculation 618; and reconstructed filter 616. For each individual adaptation sub-block, two input signals are needed: (1) the whitened error signals; and (2) the NRZ control signals with proper delay. The tap adaptation sub-block 602 also needs error signals at the FIR output with proper delay. With 3-tap DDNP filters, tap adaptation sub-block applies to the 2nd and 3rd tap of DDNP filter for different NRZ bit conditions. Gain scaling adaptation sub-block 604 applies the main tap (i.e., 1st tap bank) of DDNP filters for different NRZ bit conditions. At a given clock cycle, NRZ input signals with proper delay select one element out of the whole bank for all adaptation sub-blocks. Whitened error signals are calculated by whitened error signal calculator block 608 based on part of register information from shift register and delay line 610 (for example, certain amount of msbs) from all three adaptation sub-block, with NRZ input signals with proper delay selecting one element out of the whole register bank in calculation.

In one particular embodiment, the DDNP filter bank contains 8 different 3-tap filters dependent on 4-NRZ bits for Longitudinal targets and 3-tap Perpendicular targets; for 2-tap Perpendicular targets, the DDNP filter bank contains 4 different 3-tap filters dependent on 3-NRZ bits; both with polarity symmetry enabled. For example, the NRZ pattern ‘0000’ shares the same filter as the NRZ pattern ‘1111’ as both are non-transition pattern. The bias compensation term is dependent on 5-NRZ bits for Longitudinal targets and 3-tap Perpendicular targets with totally 32 different bias values; and 4-NRZ bits for 2-tap Perpendicular targets with totally 16 different bias values. Each DDNP filter coefficient or DDNP bias is readable/writable through a SIF/PIF register.

Other block inputs may include DDNP_enable signal, C_UPDATE signal, and Updating gain signals. The DDNP_enable signal is an ‘AND’ signal between a register set bit ‘ADAPT_ENABLE’ and a signal coming from another channel block. No adaptation should be performed during preamble with only single-tone signal available. Therefore, DDNP adaptation should be held until syncmark found signal becomes active. However, in the normal read mode (when Viterbi preliminary decisions are used to reconstruct signals), if Euclidean-distance based syncmark detection delivers syncmark found signal earlier than the first non-preamble preliminary NRZ decision from Viterbi detector, the adaptation has to be further held until Viterbi delivers its earliest non-preamble NRZ decision. Whether this would happen depends on the latency of syncmark detection versus the latency in Viterbi detection plus the intrinsic latency from preliminary decisions as well as when Viterbi trellis would start after a read gate rises. If known data pattern is used for signal reconstruction, the DDNP adaptation could be enabled right after syncmark is found.

The C_UPDATE signal is a SIF/PIF programmable register bit that allows users to control whether to recalculate Viterbi branch mean values. The default value for this bit should be 1, i.e., recalculate Viterbi branch mean values for every read gate. However, in some special testing mode, users may want to intentionally introduce gain mismatch between Viterbi branch mean values and targets by not updating Viterbi branch mean values when target changes. In such cases, ‘C_UPDATE’ is set to 0.

The Updating gain signals: ‘TAP_UG’, ‘GTAP_UG’ and ‘BIAS_UG’ are signals that control the updating gains of tap adaptation, gain scaling adaptation and bias adaptation sub-blocks respectively. Gain multiplication is implemented by right shifting accumulation term and aligning it in the accumulator.

As shown in FIG. 4, DDNP adaptation block 512 updates to DDNP ideal branch values block 514 and DDNP filter banks 506 used in Viterbi branch metric calculation module 508. Therefore, a Viterbi mean branch metric recalculation unit based on the updated DDNP filter coefficients and biases is used.

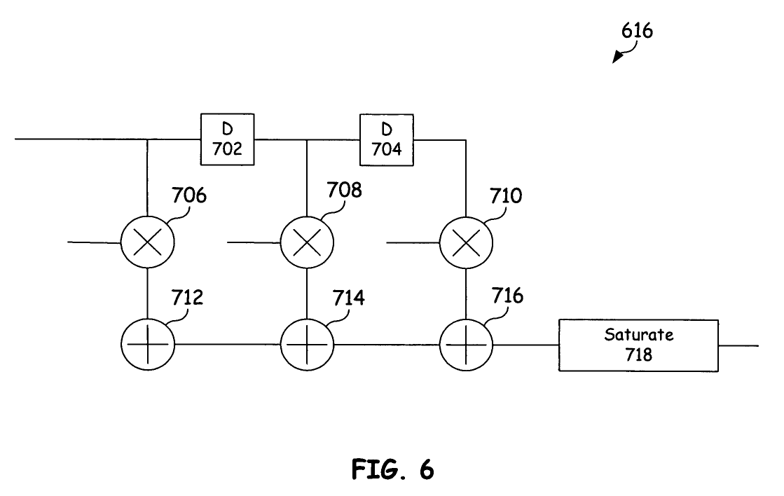

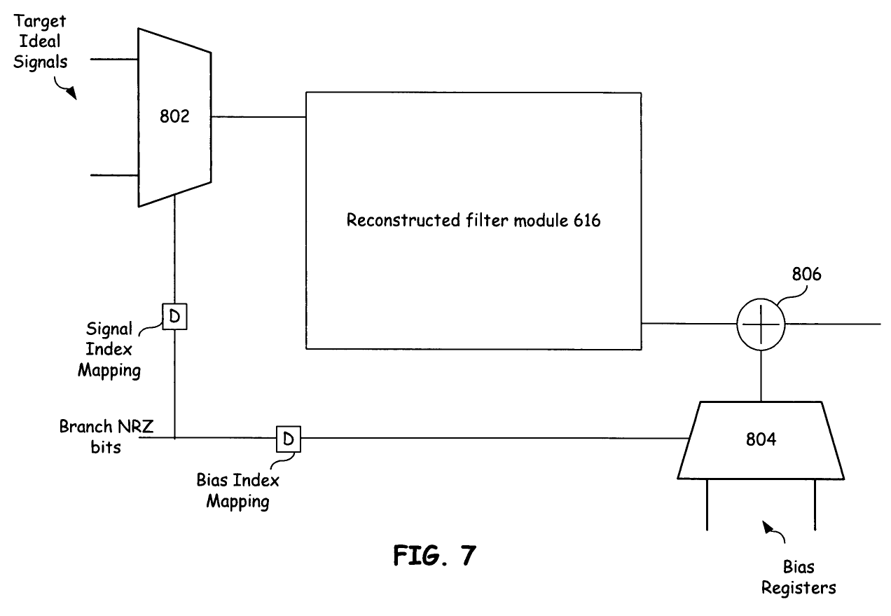

FIG. 6 is a representation of one embodiment of a reconstructed filter module 616 in accordance with embodiments of the present invention. reconstructed filter module 616 includes processing modules 702 and 704, multipliers 706, 708 and 710, adders 712, 714 and 716 and saturate module 718. Normally when a read gate rises, ideal signals equalized to short pre-target may be first calculated by a 3-tap filter as shown in FIG. 6. Then the reconstructed signals may be used to recalculate Viterbi branch mean values. For a Viterbi trellis with multiple ISI states, multiple mean branch values need to be recalculated. In order to save hardware, the recalculation is done by time sharing the DDNP filters for Viterbi (as in FIG. 7) at beginning of each sector during preamble before Viterbi starts.

FIG. 7 is a representation of one embodiment of a reconstructed filter module 616 used for recalculation of Viterbi Ideal Branch Metrics in accordance with embodiments of the present invention. The mean branch values are calculated sequentially by selecting one filter out of the DDNP filter bank for each corresponding pattern with MUX 802. Meanwhile, the DDNP filter coefficients used in DDNP Viterbi will also be sequentially updated from DDNP adaptation filter registers. The branch mean values are stored in bit memory which is accessed by Viterbi detector.

Other Block Output Signals of the adaptation block include saturation flags. Saturation flags are flags indicating whether saturation occurs during adaptation for 1st tap of DDNP filters and biases respectively. Any element in the corresponding bank saturates, the flag would be set. The 1st tap of DDNP filters could overflow when the reference pattern does not yield minimum power among all NRZ conditions. Biases could overflow/underflow when the uncompensated offset at the FIR output is too large.

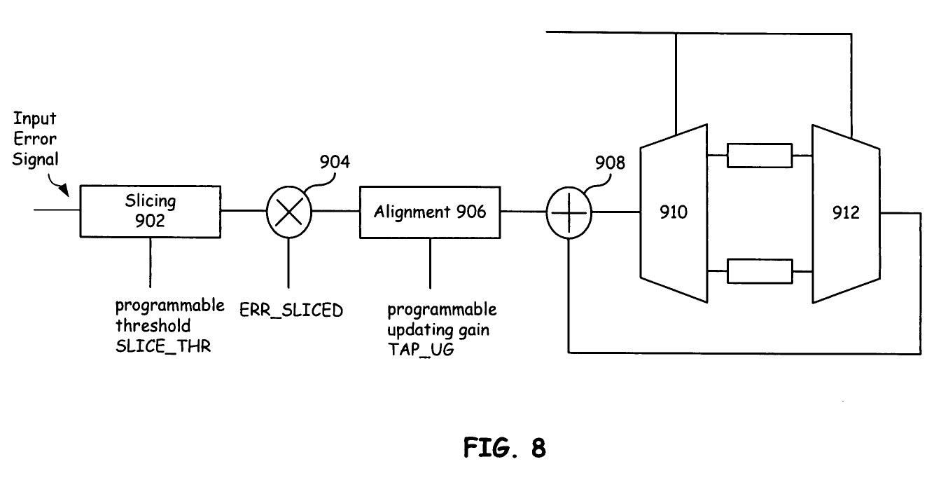

FIG. 8 is a representation of a DDNP Whitener Coefficient Adaptation block in accordance with embodiments of the present invention. One embodiment of the present invention uses half-rate clock, i.e., parallel processes two input samples in two full-rate clock period. If we want to keep the same throughput as in full-rate case, more design complexity is brought for DDNP adaptation block. For example, the whitening filter has to be doubled, as well as other hardware such as MUX/DEMUX for filter/bias selection. In the accumulation stage, more logics are needed to determine whether early and late accumulation terms should go to two different accumulators or a same one. For implementation simplification, it is decided to do a down sampling version of DDNP adaptation, i.e., only use one sample out of two in every half-rate clock. This approach brings hardware saving benefit, but requires double time for convergence. This is ok for all the three modes that DDNP adaptation is used. In self-scan mode, there is enough time for calibration; and in pre-read mode or normal read mode, when starting with good initial setting, recalibration for some environmental variations will not require too many sectors for convergence anyway.

The whitener coefficient adaptation applies quantized-LMS method. In order to avoid the adaptation converging to a trivial solution as all-zero filters, the main tap (1st tap) is not adapted in this adaptation sub-block. Therefore, the hardware implementation as showed in FIG. 5 is duplicated only for 2nd tap and 3rd tap adaptation.

FIG. 8 shows the hardware implementation of whitener coefficient adaptation in accordance with embodiments of the present invention. It is essentially a simplified LMS accumulation process. During manufacturing calibration process, users may start with an initial DDNP filter setting as default value. The calibrated DDNP coefficients may be stored on a per-surface and per-zone base. During normal user mode, upon power-up, registers values may be set based on a pre-stored zone table. The input error signal is a delayed version of ERR used in ERR_W calculation block. The input error signal is then sliced by slicing module 902 at a programmable threshold SLICE_THR. The whitened error signal is multiplied with ERR_SLICED in multiplier 904 to get accumulation signal ACCU. The output is then aligned/added to a selected tap register. The alignment within alignment module 906 is controlled by a register programmable updating gain TAP_UG. In order to align ERR_DLY with ERR_W correctly, certain amount of delay has to be applied for ERR signals where D(sig1,sig2) denotes delay between sig1 and sig2 with sig1 advancing sig2.

Also, the same NRZ pattern used to calculate ERR_W should be used in the adaptation driven by the same ERR_W signal. Therefore, NRZ_adapt_sel is a delayed version of NRZ_cal_sel as D(NRZ_cal_sel,NRZ_adapt_sel)=D(NRZ_cal_sel,ERR_W) so that NRZ_adapt_sel is properly aligned with ERR_W. Besides, any hardware implementation latencies involved in slicing circuit, accumulation circuits, etc should also be taken into consideration properly. Since whitened noise power used in Viterbi branch metric calculation is also data-dependent, the main tap may be scaled (thus the output signal gain and power) so that each whitener provides uniform power over different data patterns. One step further, a reference pattern can be used to ‘define’ a reference power and the whitened noise power for all other patterns can be normalized to the reference one.

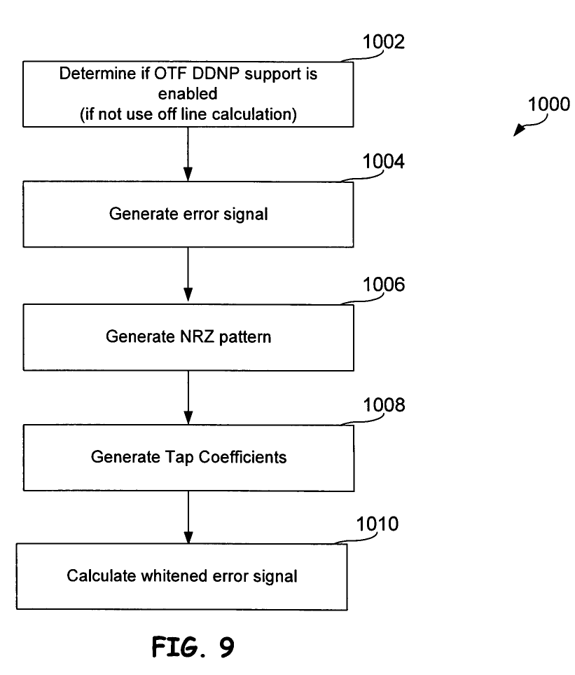

FIG. 9 provides a logic flow diagram for performing DDNP in accordance with the embodiments of the present invention. Embodiments of the present invention may optimize performance of a RW channel which may adversely be affected by noise components. Operations 1000 begin by determining whether or not an OTF DDNP functionality is to be enabled in step 1002. Assuming that this functionality is to be enabled following process will be utilized. Otherwise offline calculations may be used to determine DDNP ideal branch values. In Step 1004 an error signal may be generated. This error signal may be based on the output of a FIR filter following ADC sampling of an analog signal within the read channel. Next an NRZ pattern may be utilized and provided to a DDNP adaptation block. This NRZ pattern may be known pseudo random sequences generated by a linear feedback shift register (LFSR) or an NRZ estimate depending on the mode of operation of the controller. In Step 1008 tap coefficients may be generated by the DDNP adaptation block. These tap coefficients are based on the provided NRZ pattern, and error signal. This DDNP adaptation block will then calculate a whitened error signal based on the error signal, NRZ pattern and tap coefficients. This may then be provided to a DDNP Viterbi branch metric calculation module such as that discussed with reference to FIG. 4. This may then be used by the device controller to produce an improved NRZ estimate that takes into account moist component in the read back signal such as channel noise, front end equalizer, and nonlinearity factors.

Embodiments of the present invention provide a data-dependent noise predictive (DDNP) adaptation module operable to support Viterbi branch metric calculations within a hard disk drive (HDD) controller. This DDNP adaptation module includes a DDNP filter tap coefficient adaptation module, a DDNP filter gain scaling module, and a DDNP bias compensation module. The combination of the DDNP filter tap coefficient adaptation module, the DDNP filter gain scaling module, and the DDNP bias compensation module is operable to receive an error signal and a NRZ pattern and produce tap coefficients. A whitened error signal calculation module coupled to the DDNP filter tap coefficient adaptation module, the DDNP filter gain scaling module, and the DDNP bias compensation module, the whitened error signal calculation module operable to calculate a whitened error signal based on the error signal, NRZ pattern, and tap coefficients. This whitened error signal is used to support the Viterbi branch metric calculations.

As one of average skill in the art will appreciate, the term “substantially” or “approximately”, as may be used herein, provides an industry-accepted tolerance to its corresponding term. Such an industry-accepted tolerance ranges from less than one percent to twenty percent and corresponds to, but is not limited to, component values, integrated circuit process variations, temperature variations, rise and fall times, and/or thermal noise. As one of average skill in the art will further appreciate, the term “operably coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. As one of average skill in the art will also appreciate, inferred coupling (i.e., where one element is coupled to another element by inference) includes direct and indirect coupling between two elements in the same manner as “operably coupled”. As one of average skill in the art will further appreciate, the term “compares favorably”, as may be used herein, indicates that a comparison between two or more elements, items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

Although the present invention is described in detail, it should be understood that various changes, substitutions, and alterations can be made hereto without departing from the spirit and scope of the invention as described by the appended claims.

What is claimed is:

1. A data-dependent noise predictive (DDNP) adaptation module operable to support Viterbi branch metric calculations within a hard disk drive (HDD) controller, comprising:
a DDNP filter tap coefficient adaptation module;
a DDNP filter gain scaling module;
a DDNP bias compensation module, the DDNP filter tap coefficient adaptation module, the DDNP filter gain scaling module, and the DDNP bias compensation module operable to:
receive an error signal and a NRZ pattern; and
produce tap coefficients; and
a whitened error signal calculation module coupled to the DDNP filter tap coefficient adaptation module, the DDNP filter gain scaling module, and the DDNP bias compensation module, the whitened error signal calculation module operable to calculate a whitened error signal based on the error signal, NRZ pattern, and tap coefficients.

2. The DDNP adaptation module of claim 1, wherein the NRZ pattern comprises:
a known data pattern when the HDD controller operates in a self scan mode; and
a NRZ estimate from a Viterbi detector when the HDD controller operates in a read mode.

3. The DDNP adaptation module of claim 1, wherein offline calibration provides a backup input to support the Viterbi branch metric calculations.

4. The DDNP adaptation module of claim 1, wherein a DDNP enable signal selects between an output of:
the data-dependent noise predictive (DDNP) adaptation module to support the Viterbi branch metric calculations; and
an offline calibration module to support the Viterbi branch metric calculations.

5. The DDNP adaptation module of claim 1, wherein the DDNP adaptation module is enabled during:
a self scan mode;
a pre-read mode; and
normal read mode.

6. The DDNP adaptation module of claim 1, wherein the NRZ pattern comprises a pseudo-random sequence generated by a linear feedback shift register.

7. A magnetic disk drive comprising:
a magnetic disk operable to store data therein;
a RW channel, that reads/writes data to and from the magnetic disk; and
a device controller operably coupled to the RW channel, the device controller comprising:
an analog to digital converter operable to sample an analog signal from the RW channel;
a finite impulse response (FIR) filter operable to process the sampled analog signal;
a data-dependent noise predictive (DDNP) filter bank; and
a DDNP Viterbi branch metric calculation module supported by a DDNP adaptation module, the DDNP adaptation module comprising:
a DDNP filter tap coefficient adaptation module;
a DDNP filter gain scaling module;
a DDNP bias compensation module, the DDNP filter tap coefficient adaptation module, the DDNP filter gain scaling module, and the DDNP bias compensation module operable to:
receive an error signal and a NRZ pattern; and
produce tap coefficients; and
a whitened error signal calculation module coupled to the DDNP filter tap coefficient adaptation module, the DDNP filter gain scaling module, and the DDNP bias compensation module, the whitened error signal calculation module operable to calculate a whitened error signal based on the error signal, NRZ pattern, and tap coefficients.

8. The magnetic disk drive of claim 7, further comprising an error signal calculation module operable to calculate the error signal based on the NRZ pattern and an output of the FIR filter.

9. The magnetic disk drive of claim 7, wherein the NRZ pattern comprises:
a known data pattern when the HDD controller operates in a self scan mode; and
a NRZ estimate from a Viterbi detector when the HDD controller operates in a read mode.

10. The magnetic disk drive of claim 7, wherein offline calibration provides a backup input to support the Viterbi branch metric calculations.

11. The magnetic disk drive of claim 7, wherein a DDNP enable signal selects between an output of:
the data-dependent noise predictive (DDNP) adaptation module to support the Viterbi branch metric calculations; and
an offline calibration module to support the Viterbi branch metric calculations.

12. The magnetic disk drive of claim 7, wherein the DDNP adaptation module is enabled during:
a self scan mode;
a pre-read mode; and
normal read mode.

13. The magnetic disk drive of claim 7, wherein the NRZ pattern comprises a pseudo-random sequence generated by a linear feedback shift register.

14. A hard disk drive (HDD) controller operable to read/write (RW) data to a storage media comprising:
an analog to digital converter (ADC) operable to sample an analog signal from a read/write (RW) channel;
a finite impulse response (FIR) filter operable to process the sampled analog signal;
an error signal calculation module operable to calculate an error signal based on a NRZ pattern and an output of the FIR filter;
a data-dependent noise predictive (DDNP) filter bank; and
a DDNP Viterbi branch metric calculation module supported by a DDNP adaptation module, the DDNP Viterbi branch metric calculation module operable to produce a NRZ estimate, the DDNP adaptation module comprising:
a DDNP filter tap coefficient adaptation module;
a DDNP filter gain scaling module;
a DDNP bias compensation module, the DDNP filter tap coefficient adaptation module, the DDNP filter gain scaling module, and the DDNP bias compensation module operable to:
receive the error signal and the NRZ pattern; and
produce tap coefficients; and
a whitened error signal calculation module coupled to the DDNP filter tap coefficient adaptation module, the DDNP filter gain scaling module, and the DDNP bias compensation module, the whitened error signal calculation module operable to calculate a whitened error signal based on the error signal, NRZ pattern, and tap coefficients.

15. The HDD Controller of claim 14, wherein the NRZ pattern comprises:
a known data pattern when the HDD controller operates in a self scan mode; and
a NRZ estimate from a Viterbi detector when the HDD controller operates in a read mode.

16. The HDD Controller of claim 14, wherein offline calibration provides a backup input to support the Viterbi branch metric calculations.

17. The HDD Controller of claim 14, wherein a DDNP enable signal selects between an output of:
the data-dependent noise predictive (DDNP) adaptation module to support the Viterbi branch metric calculations; and
an offline calibration module to support the Viterbi branch metric calculations.

18. The HDD Controller of claim 14, wherein the DDNP adaptation module is enabled during:
a self scan mode;
a pre-read mode; and
normal read mode.

19. The HDD Controller of claim 14, wherein the NRZ pattern comprises a pseudo-random sequence generated by a linear feedback shift register.
